(19) United States
(12) Patent Application Publication
(10) Pub. No.: US 2012/0012353 A1
(43) Pub. Date: Jan. 19, 2012

(54) SIDE HANDLE

(75) Inventors: Alexander Foerster, Wiesbaden (DE); Reimund Becht, Huenfelden (DE)

(73) Assignee: BLACK AND DECKER INC., Newark, DE (US)

(21) Appl. No.: 13/183,724

(22) Filed: Jul. 15, 2011

(30) Foreign Application Priority Data
Jul. 15, 2010 (GB) 1011978.2

(51) Int. Cl. B25D 17/24; B25F 5/02

(52) U.S. Cl. 173/162.2

(57) ABSTRACT

A side handle for a power tool comprising: a central bar; a tubular grip which is mounted on and surrounds the central bar via a vibration dampener; the vibration dampener comprising a spring having a central plate, which is mounted in a non moveable manner on the central bar, and a plurality of resiliently deformable arms attached to the plate and which extend away from the plate towards the grip, the ends of each of the arms being non moveably attached to the grip.

### CROSS-REFERENCE TO RELATED APPLICATIONS

This application claims priority, under 35 U.S.C. §119(a)-(d), to UK Patent Application No. GB 10 119 78.2 filed Jul. 15, 2010, the contents of which is incorporated herein by reference in its entirety. EP2082846 filed on Jan. 21, 2009 is also incorporated herein by reference in its entirety.

### FIELD OF THE INVENTION

The present invention relates to a side handle for a power tool, and in particular, to a side handle for a drill.

### BACKGROUND OF THE INVENTION

Drills, in particular, hammer drills, comprise a main housing in which is mounted a spindle and a motor, which rotatingly and/or axially drives the spindle via gears and/or a hammering mechanism, also located within the housing. The spindle transfers the rotational and/or axial movement of the spindle to a cutting tool, such as a drill bit, via a chuck or tool holder attached to the end of the spindle, forward of the main housing. Typically, such drills have two handles, a rear handle attached at the rear of the main housing and a side handle attached towards the front of the main housing, on one side of the main housing. Often, the side handle can be attached to either side of the main housing.

One type of side handle comprises a hand grip which is attached at one end to a base, which is attached to the side of main housing, and which extends away from the base and the housing in a direction generally perpendicular to the longitudinal axis of the spindle of the drill.

A problem with power tools, in particular drills, is that they generate a large amount of vibration during their operation. The transfer of the vibration from the tools to the hands of the operator can lead to injury to the hands of the operator and therefore it is desirable to minimise the amount of vibration transferred. One way of achieving this to provide a vibration dampener between the hand grip and the base to reduce the amount of vibration transferred from the base to the hand grip.

EP2082846, as published, describes such a design of side handle for a drill in paragraphs 45 to 52 with reference to FIGS. 7 to 13. The side handle comprises a hand grip 84 (using the same reference numbers as EP2082846) which is attached to a bolt 106 via two vibration dampeners 118, 120. The bolt 106 attaches to a base 80. The dampeners 118, 120 are made from resilient rubber. During use of such a side handle, the operator applies pressure to the hand grip 84 in a direction generally parallel to the longitudinal axis of the spindle of the drill to which the handle is attached, which is perpendicular to longitudinal axis of the hand grip. As such, this applies a rotation force onto the hand grip 84 in a direction perpendicular to the longitudinal an axis of the hand grip about an axis of rotation located in close proximity to the base 80. This results in a large degree of sideways pressure being placed on the dampener 118 closest to the base 80, which, due to it being made from rubber, becomes compressed on one side. This reduces the performance of the vibration dampener 118.

### BRIEF SUMMARY OF THE INVENTION

The present invention overcomes or at least reduces the problems associated the design of side handle disclosed in EP2082846.

Accordingly, there is provided a side handle for a power tool comprising:
a central bar;
a tubular grip which is mounted on and surrounds the central bar via a vibration dampener;
the vibration dampener comprising a spring having a central plate, which is mounted in a non moveable manner on the central bar, and a plurality of resiliently deformable arms attached to the plate and which extend away from the plate towards the grip, the ends of each of the arms being non moveably attached to the grip.

### BRIEF DESCRIPTION OF THE DRAWINGS

An embodiment of the present invention will now be described with reference to the accompanying drawings of which:

FIG. 1 shows an exploded side view of a the side handle according to the present invention;

FIG. 2 shows a perspective end view of the side handle (excluding the base);

FIG. 3 shows a perspective end view of the side handle with the plastic cap in an exploded position;

FIG. 4 shows a perspective end view of the side handle with the spring and plastic cap in an exploded position;

FIG. 5 shows a cut away rear perspective view; and

FIG. 6 shows a vertical cross sectional view.

An embodiment of a side handle according to the present invention will now be described. The embodiment is for a side handle for a drill.

### DETAILED DESCRIPTION OF THE INVENTION

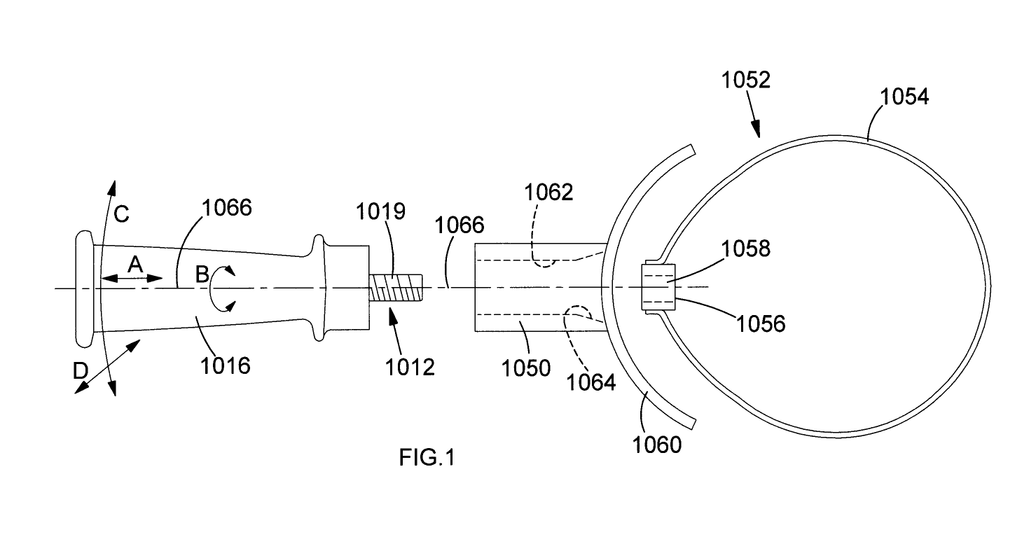

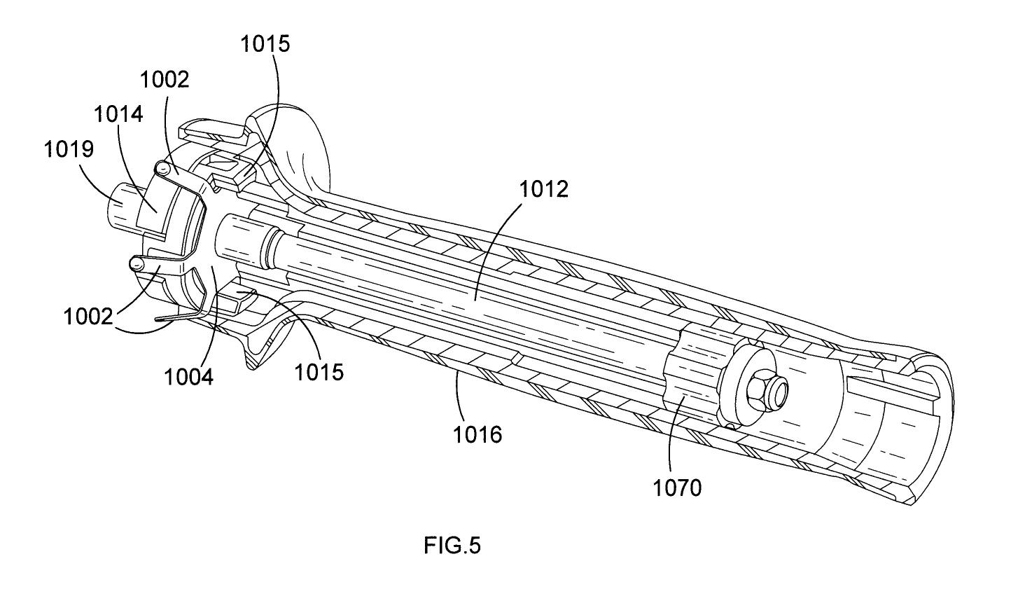

Referring to FIG. 1, the side handle comprises a plastic grip 1016 which is mounted on a bolt 1012 via a vibration dampening mechanism (as shown in FIG. 5 and which is described in more detail below). The bolt 1012 has a threaded end 1019 which projects from the end of the grip 1016. The side handle comprises a base 1050 and an attachment loop 1052. The attachment loop 1052 comprises a flexible metal strip 1054 which is attached at both ends to a nut 1056 which has a threaded passage 1058 formed through it. The base 1050 has a curved support 1060 and a tubular passageway 1062 which passes through its length. In use, the metal strip 1054 is wrapped around the body of a drill (not shown). The nut 1056 is inserted into the tubular passage 1062 from the side of the base 1050 containing the curved support 1060. The threaded end 1019 of the bolt 1012 is inserted into the other end of the tubular passage 1062 until it engages with the threaded passage 1058 of the nut 1056. The bolt 1012 is then rotated using the hand grip 1016, causing the threaded end 1019 of the bolt 1012 to screw into the threaded passage 1058 of the nut 1056. As the threaded end 1019 of the bolt 1012 screws into the threaded passage 1058 of the nut 1056, the nut 1056 is drawn towards the grip 1016. This causes the nut 1056 and metal strip 1054 to be drawn into the tubular passage 1062, resulting in it tightening around the body of the drill. Once the metal strip 1054 is wrapped tightly around the body of the drill, the grip 1016 is prevented from further rotation. At this point the curved support 1060 also abuts the side of the drill. The side handle is thereby secured to the drill. In order to release the side handle, the grip 1016 is rotated in the opposite direction, thereby unscrewing the threaded end 1019 of the bolt 1012 from the nut 1056. The entrance 1064 of the tubular passage 1062 is tapered to facilitate the entry and exit of the nut 1056 and metal strip 1054 into the tubular passage 1062.

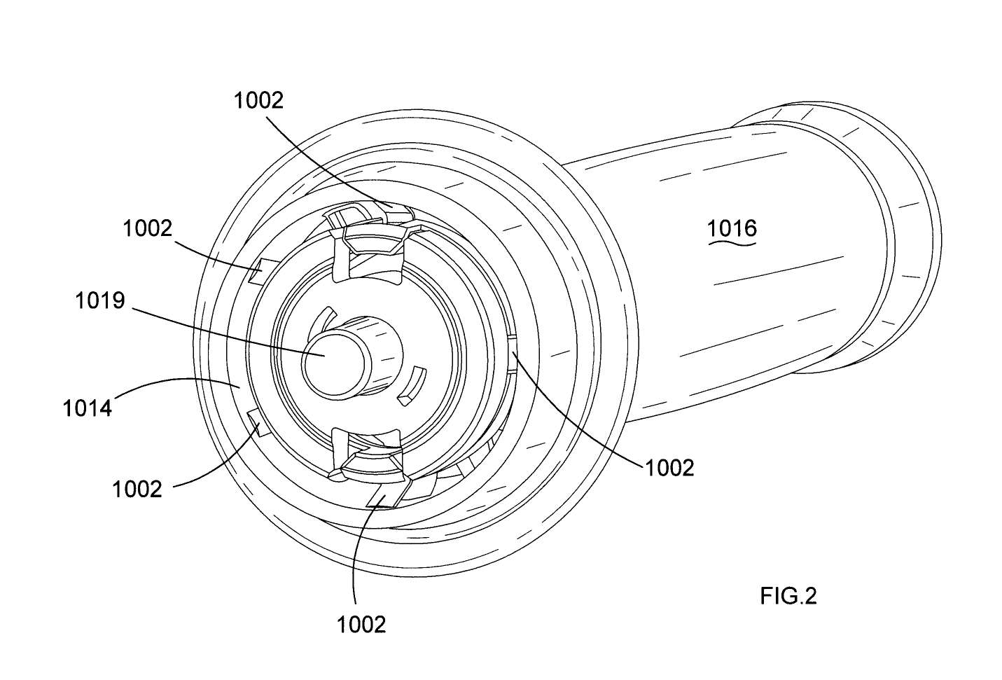

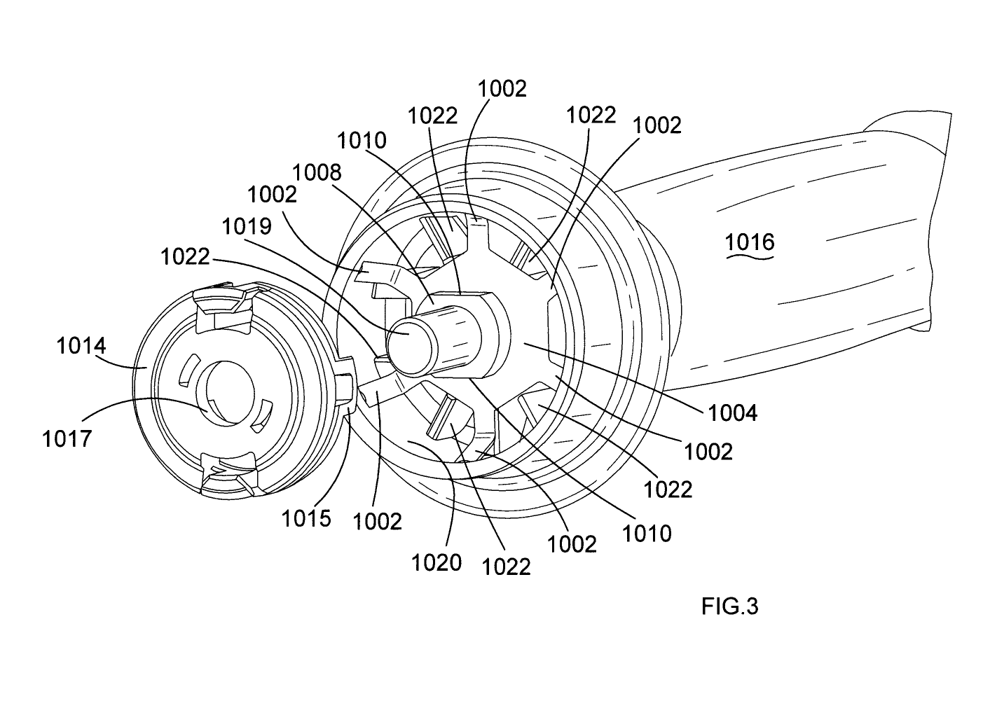

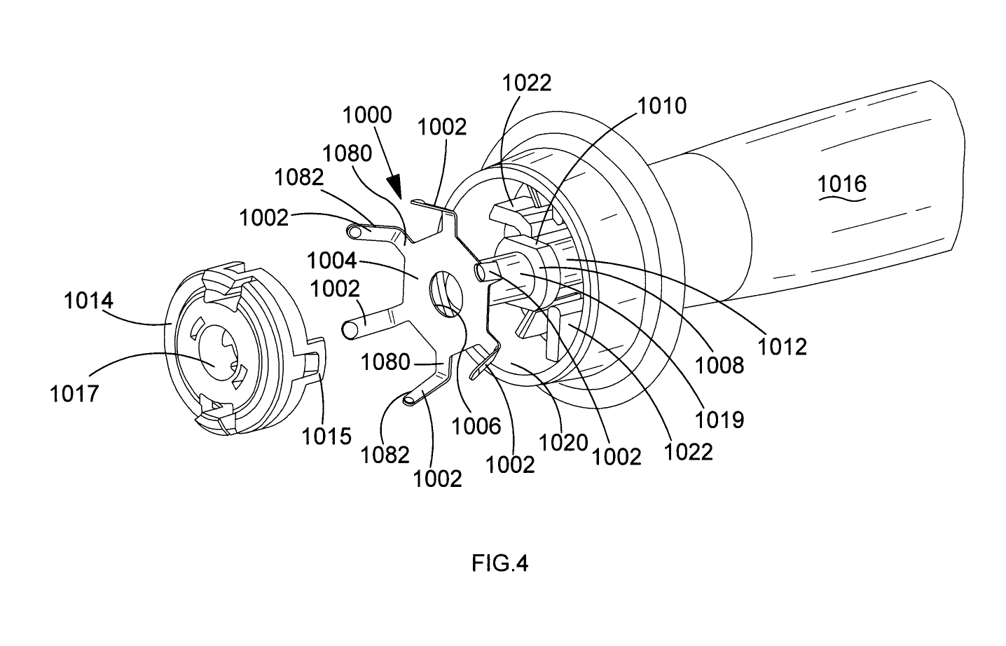

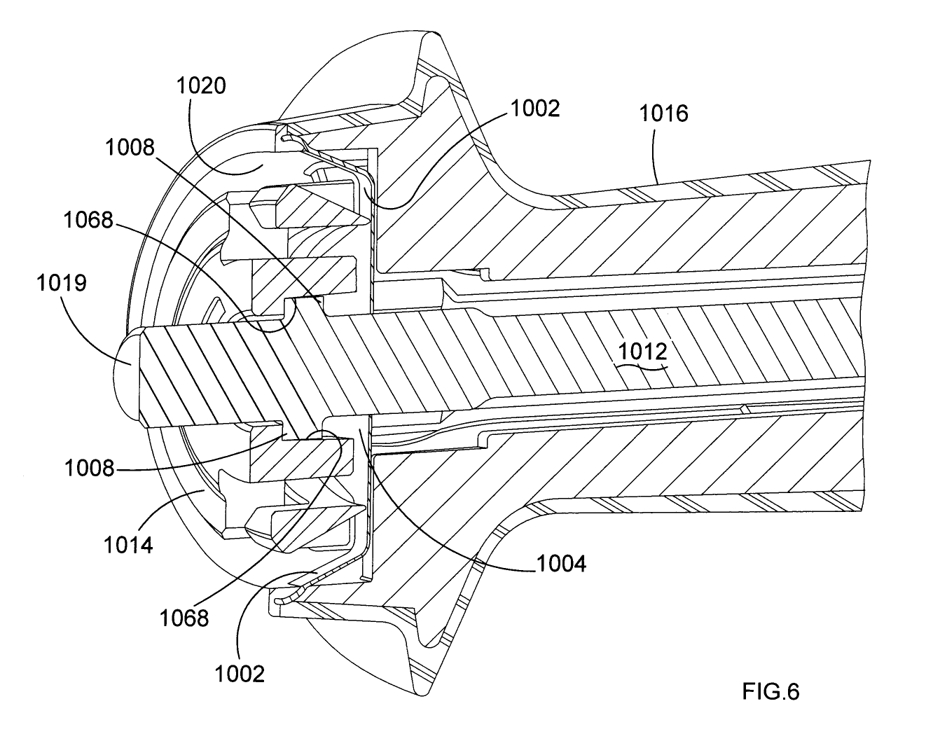

The vibration dampening mechanism will now be described with reference to FIGS. 2 to 6. The vibration dampening mechanism comprises a metal spring 1000. The metal spring 1000 comprises six arms 1002 which are resiliently deformable and which are integrally formed with and extend from a central hexagonal plate 1004 in a symmetrical shape. Each arm 1002 is L shaped with the first part 1080 extending away from the plate 1004 in the plane of the plate 1004. The second part 1082 extends at an angle to the first part. A circular aperture 1006 is formed through the plate 1004. Formed on the bolt 1012 is a flange 1008 having two flat sides 1010 which extend tangentially to the longitudinal axis 1066 of the bolt 1012. The spring 1000 is located on the circular shank of the bolt 1012 immediately behind the flange 1008. The spring 1000 can freely rotate about the shank of the bolt 1012. The ends of the arms 1002 are rigidly connected to the plastic grip 1016 using rivets. However it will be appreciated that the ends of the arms 1002 can be connected using other means such as glue or be encased within the wall of the grip 1016 which would be molded around the ends of the arms 1002.

The plastic cap 1014 comprises two clips 1015 and a recess 1068 which corresponds to the shape of the flange 1008 on the bolt 1012. A circular aperture 1017 is formed through the base of the recess. The plastic cap is mounted on the shank of the bolt in front of the flange 1008, the flange 1008 locating in the recess 1068 with the front end 1019 of shank passing through the aperture 1017. The clips 1015 clip onto the edges of the plate 1004, holding the plate 1004 against the rear side of the flange. By clipping the plate 1004 to the cap 1014, both the spring 1000 and cap 1014 are locked onto the bolt 1012 around the flange 1008. As the sides of the plate 1004 are straight, the clips 1015 prevent rotational movement between the cap 1014 and the plate 1004. As the flange 1008 has flat sides 1010, the flange 1008 can not rotate within the recess 1068 and therefore the cap 1014 can not rotate relative to the flange 1008 and bolt 1012. Thus rotation of the flange 1008 results in rotation of the cap 1014. This in turn results in the plate 1004 being prevented from rotating relative to the flange 1008 and bolt 1012. As the cap 1014, located on the bolt 1012 on one side of the flange 1008, is clipped to the plate 1004, located on the bolt 1012 on the other side of the flange 1008, both the cap 1014 and plate 1004 are prevented from axially sliding along the bolt 1012.

The plastic grip 1016 can move relative to the bolt 1012 by the bending of the arms 1002. The grip can move axially (Arrow A) relative to the bolt 1012 or rotationally (Arrow B) about the longitudinal axis 1066 of the bolt 1012 and perpendicularly (Arrows C and D) to longitudinal axis 1066 of the bolt 1012 due to the flexible nature of the arms 1002. The arms 1002 absorb vibration, reducing the amount transferred from the bolt 1012 to the grip 1016. However, the resilience of the arms 1012 is sufficient to support the pressure applied to the grip 1012 by the operator during use whilst reducing vibration.

Formed on the inner walls 1020 of the grip 1016 are ribs 1022. The ribs 1022 inside of the grip 1016 are located so that, when the grip 1016 is rotated about the longitudinal axis 1066 of the bolt 1012 relative to the plastic cap 1014 (by the bending of the arms 1002), the ribs 1022 would engage with the sides of the clips 1015. When no pressure is applied to the grip 1016, the ribs 1022 are located with a space between the ribs 1022 and the clips 1015. In order to screw or unscrew the bolt 1012 from the nut 1056, the user rotates the grip 1016. Rotational movement of the grip 1016 is initially transferred to the bolt 1012 via the arms 1002 of the spring 1000. If the bolt 1012 is held rigidly in the nut 1056, rotation of the grip 1016 results in the arms 1002 bending. However, once grip 1016 has been rotated sufficiently relative to the bolt 1016, the ribs 1022 engage with the sides of the clips 1015 of the cap 1014, the subsequent rotational movement then being transferred via the ribs 1015 directly to the cap 1014 via the clips 1015, and hence to the bolt 1016. This prevents damage to arms 1002 as they are prevented from being bent too much.

It will be appreciated that the design of the arms 1002 can arranged to alter the amount of resilience in the directions of Arrows A, B, C and D, or even prevent movement in any one of those directions. The use of L shaped arms is particular beneficial in providing sufficient resilience in the direction of Arrow C so that, when the operator applies pressure to the hand grip 1016 in a direction generally parallel to the longitudinal axis of a spindle of the drill to which the handle is attached, which is perpendicular to longitudinal axis of the grip 1016, the arms 1002 provide sufficient support to the grip 1016 whilst providing good vibration dampening to the grip 1016.

Located at the far end of the bolt 1012 remote from the flange 1008, is a second vibration dampener 1070. The dampener 1070 has the same design as the second dampener 120 (using the same reference numbers as EP2082846) described in EP2082846.

1. A side handle for a power tool comprising:
a central bar;
a tubular grip which is mounted on and surrounds the central bar via a vibration dampener;
the vibration dampener comprising a spring having a central plate, which is mounted in a non moveable manner on the central bar, and a plurality of resiliently deformable arms attached to the plate and which extend away from the plate towards the grip, the ends of each of the arms being non moveably attached to the grip.

2. The side handle as claimed in claim 1, wherein the plane of the plate is perpendicular to a longitudinal axis of the bar.

3. The side handle as claimed in claim 1, wherein the arms are located symmetrically around the bar.

4. The side handle as claimed in claim 1, wherein there are six arms.

5. The side handle as claimed in claim 4, wherein the periphery of the plate is hexagonal in shape, each of the arms being attached to a corner of the plate.

6. The side handle as claimed in claim 1, wherein the arms are made from metal.

7. The side handle as claimed in claim 1, wherein the plate is made from metal.

8. The side handle as claimed in claim 1, wherein the arms and plate are formed integrally.

9. The side handle as claimed in claim 1, wherein there is further provided a cap which is non-moveably mounted on the bar and which is non moveably attached to the plate.

10. The side handle as claimed in claim 9, wherein the bar further comprises a flange, the plate being mounted on the bar on one side of the flange adjacent the flange, the cap being mounted on the bar other side of the flange adjacent the flange, the cap being attached to the plate to sandwich the flange between the cap and the plate to prevent axial movement of the plate and cap along the bar.

11. The side handle as claimed in claim 10, wherein the flange locates within a recess formed within the cap, the shape of the of the flange corresponding to the shape of the recess, the shape being non circular to prevent any rotational movement of cap around the bar.

12. The side handle as claimed in claim 9, wherein the grip comprises at least one rib and the cap comprises at least one stop, the at least one rib being located relative to the at least stop so that, when the grip is rotated about the longitudinal axis 1066 of the bar relative to the plastic cap, the at least rib would engage with the at least one stop and when no rotational force is applied between the grip and cap, the at least one rib and at least one stop are located with an angular space between them.

13. The side handle as claimed in claim 12, wherein the at least one stop also comprises a clip which attaches the cap to the plate.

14. The side handle as claimed in claim 12, wherein rotation movement of the grip is initially transferred to the bolt via the arms of the spring if the bending force of the arms is greater than the resistive torsion force between the grip and the cap.

15. The side handle as claimed in claim 14 wherein, if the resistive torsion force between the grip and the cap is greater than the bending force of the legs, rotational movement of the grip around the bar causes the arms to bend until the at least one rib engages with the at least one stop, any subsequent rotational movement of the grip being transferred directly to the cap via the at least one rib directly engaging the at least one stop.
